(19) United States
(12) Patent Application Publication
(10) Pub. No.: US 2004/0108668 A1
(43) Pub. Date: Jun. 10, 2004

(54) Connecting structure of a golf cart

(76) Inventor: Chong-Yong Liu, Tainan City (TW)

Correspondence Address: Chong-Yong Liu, No. 2, Alley 492, Hai Tian Rd. Sec. 2, Tainan City, TW

(21) Appl. No.: 10/316,583

(22) Filed: Dec. 9, 2002

(51) Int. Cl. B62B 1/00

(52) U.S. Cl. 280/47.27

(57) ABSTRACT

A connecting structure of a golf cart, and more particularly to a connecting structure to set a golf bag with crutches on a golf cart, comprising by an upper support, a connecting tube, and a lower support, when move the golf cart, prevent the golf cart rocking and damaging the golf tools from the rise and fall of the field, provide the firmness and convenience to prevent the user from increasing the harassment, affect the mood, to exert the golf technique level.

### BACKGROUND OF THE INVENTION

1. Field of the Invention

The present invention relates to a connecting structure of a golf cart, and more particularly to a connecting structure to set a golf bag with crutches on a golf cart, when move the golf cart, prevent the golf cart rocking and damage the golf tools from the rise and fall of the field, provide the firmness and convenience to prevent the user from increasing the harassment, affect the mood, to exert the golf technique level.

2. Description of the Related Art

A golf bag with crutches 1 shown in FIGS. 1 and 2, is comprising by a bag 11 put in the tools and implements establishing a arc channel 12 having two prominent pedestals 121 on the top of the bag 11 connect with the two connecting rods 13 and a base to be triangular form and to prevent the golf bag with crutches 1 from dumping tools and implements put in the golf bag 11; then turn back the connecting rods 13 to close the golf bag with crutches 1.

However the weight of the golf tools and implements and the golf bag with crutches 1 is heavy, the long time carry negative makes the carrier feeling fatigue, therefore a golf cart 2 in accordance with the prior art shown in FIG. 3 to be invented and be convenient for the ambulation of the golf bag with crutches 1 and the golf tools and implements, the golf cart 2 established two connecting structures 20, includes a symmetrical round arc support 203, having two rectangular hole 205 on the edges of two ends, a leather belt 201 can pass through, one end of the leather belt 201 is a male button 204 and the other end of the leather belt 201 is a female button 202; the two connecting structures 20 are set on the top and on the end of the tube 21 of the golf cart 2.

As shown in FIG. 4, when the golf bag with crutches 1 being closed, put the calabash-board 14 in the bottom of the golf bag with crutches 1 on a flection part 211 in the end of the tube 21 of the golf cart 2, the flection part 211 can hold the whole golf bag with crutches 1; the round arc support 203 on the top and the end of the golf cart 2 having the leather belt 201, make longer the leather belt 201 until the mail button 204 can button up the female button 202; the golf bag with crutches 1 being combined with the golf cart 2.

So know using and ambulation of the golf bag, have the weakness as following:

1. A golf bag without crutches can't be stand; it is inconvenient for the carrier to solving the golf bag without crutches to bottom by the shoulder, the golf bag without crutches needs to being supported continuously with hands.

2. The golf bag with crutches 1 can be stand, but when moving it, need to consume a great deal of physical strength, causing the partial pressure on the back of the carrier, fatigue, endanger the health, it is inconvenient and has the latent risk.

3. The prior golf cart 2 can connect with the golf bag without crutches, however when the golf bag without crutches dismantled from the golf cart 2, can't be stand; the golf bag without crutches needs to be supported, or to be dumped on the ground, causing the golf bag or the golf tools to have the contamination.

4. If the prior golf cart 2 connect with the golf bag with crutches 1, the prominent parts of the golf bag with crutches 1, such as prominent pedestals 121, convex jaws 15, connecting bars 16, a calabash-board 14 in the bottom, easily rub and knock against the round arc support 203, the tube 21 and the bottom flection part 211 of the golf cart 2 support, causing the structures of the golf cart 2 and the golf bag 1 with crutches to be damaged, reducing the durability of the golf cart 2 and the golf bag 1 with crutches; besides, the bottom flection part 211 of the tube 21 of the golf cart 2 supports the weight of the golf bag with crutches 1 and the golf tools and implements for long time, the easy creation transform, making flection partial 211 to lose to prop up originally possessed” have the golf bag of pay” of effect, so lose its function easily;The leather belt is partial and talk, if use belt 201 is easy to be elastic deformed and lose the flexibility, then the combination of the golf bag with crutches 1 and the golf cart 2 isn't form enough, so the usage of the leather belt 201 contains its latent inconvenience and risks.

### SUMMARY OF THE INVENTION

A connecting structure of a golf cart comprises by an upper support, a connecting tube, and a lower support.

The upper support, comprising by a [symbol] -component, two <-fixedly buttons, two screws, two screw nuts, and the lower support, having two prominent pedestals on the edges of the end of two sides, the down base is a calabash-board, having two holes, connecting with the hollow tube by screws and screw nuts and connecting a L-metal frame with the down base of the connecting tube by a screw rod and screw nuts, then established the upper support on the top of the connecting tube.

### BRIEF DESCRIPTION OF THE DRAWINGS

FIG. 1 is a perspective view of a closed golf bag;

FIG. 2 is a perspective view of an opened golf bag;

FIG. 3 is a perspective view of a golf cart in accordance with the prior art;

FIG. 4 is a perspective view of a golf bag connected with a golf cart in accordance with the prior art;

FIG. 5 is a perspective view of a connecting structure of a golf cart;

FIG. 6 is a perspective view of a connecting structure of a golf cart set on a golf cart;

FIG. 7 is a perspective view of a connecting structure of a golf cart without a golf bag;

FIG. 8 is an operate diagram of a connecting structure of a golf cart;

FIG. 9 is an operate diagram of a connecting structure of a golf cart;

FIG. 10 is an operate diagram of a connecting structure of a golf cart, and

FIG. 11 is a perspective view of a connecting structure of a golf cart with a golf bag with crutches set on a golf cart.

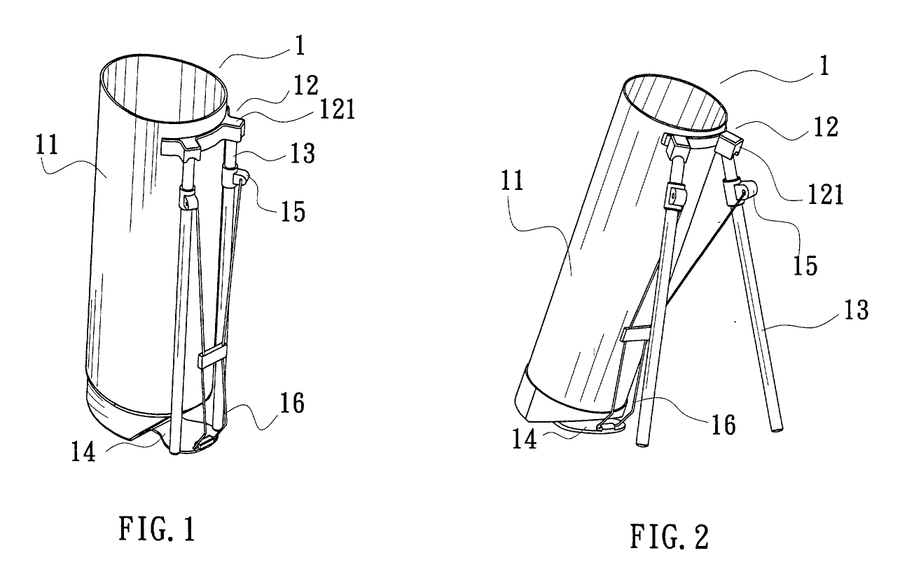

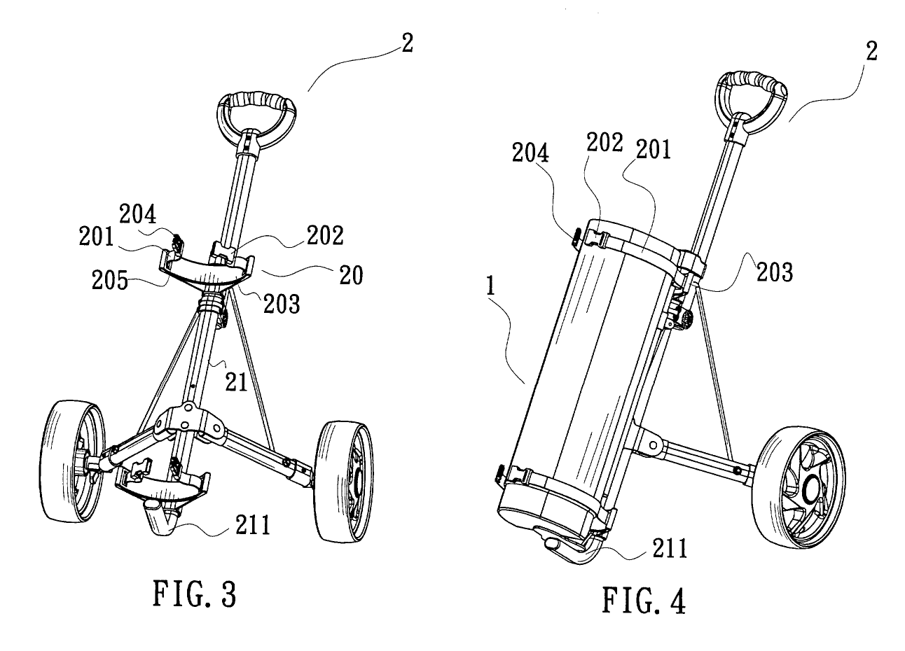

### DETAILED DESCRIPTION OF THE INVENTION

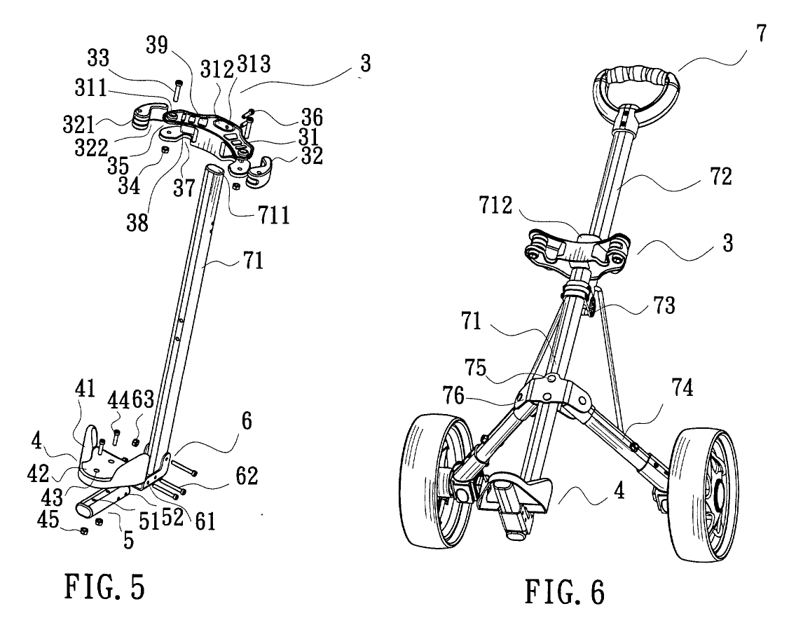

Referring to the FIG. 5, a connecting structure of a golf cart comprises by an upper support 3, a tube 71, and a lower support 4.

The upper support 3, comprising by a [symbol] -component 31, two <-fixedly buttons 32, two screws 33, two screw nuts 34, the [symbol] -component 31 is symmetrical, having several different sizes of squares 39 on the upper flat, the peripheries of the squares 39 and the upper flat of the [symbol] -component 31 are protrudent, the upper flat having a round drill hole 311 on each edges of two ends, having a through hole 312 in the center, and the lower flat symmetrizes and equals the upper flat, the only different part is the place near the through hole 312 having a concave 37 on the lower flat; two hollow parts 35 being between the upper flat and lower flat.

The round protrudent part 323 of the <-fixedly buttons 32 aim at up and down holes 321, the concave 37 of the <-fixedly buttons 32 toward the [symbol] -component 31, the screw 33 pass through the round drill holes 311 and the through holes 321 of the <-fixedly buttons 32, fastening with the screw nuts 34 on the two ends of the [symbol] -component 31, the spare parts of the upper support 3 are being combined.

The connecting tube 71, a long and hollow tube, the shapes of the upper and lower flats 711 are similar with the through hole 312 of the upper support 3, but smaller than the through hole 312 of the upper support 3.

The lower support 4, having two prominent pedestals 41 on the edges of the end of two sides, the down base 42 is a calabash-board, having two holes 43.

The through holes 312 of the upper support 3 aim at the upper and lower flats 711 of the connecting tube 71 and slip in the up and down hollow parts 35 on the back of the upper support 3 to the position that could see the two round holes 313 in the top back of the connecting tube 71, passing the screw 36 through the round holes 313 then fastening the screw 36, and the produnent parts of the two screws 36 are against the up and down flats of the upper support 3, the upper support 3 is being combined with the connecting tube 71.

The two screws 44 pass through the two holes 43 of the lower support 4, and pass through the two round holes 51 of a hollow tube 5 and fasten with the screw nuts 45, then the two round holes 52 on the left and right sides of the hollow tube 5 aim at a round hole 61 of a L-metal frame 6, passing through a screw rod 62 and fastening with screw nuts 63, the connecting structure of the golf cart is being combined.

Referring to FIG. 6, the central part of the connecting tube 71 is being riveted with an immobile piece 76 on the wheel frame 74 of the golf cart 7, an immobile article 712 slips in the upper flat 711 of the connecting tube 71, the connecting structure of the golf cart is being combined with the golf cart 7.

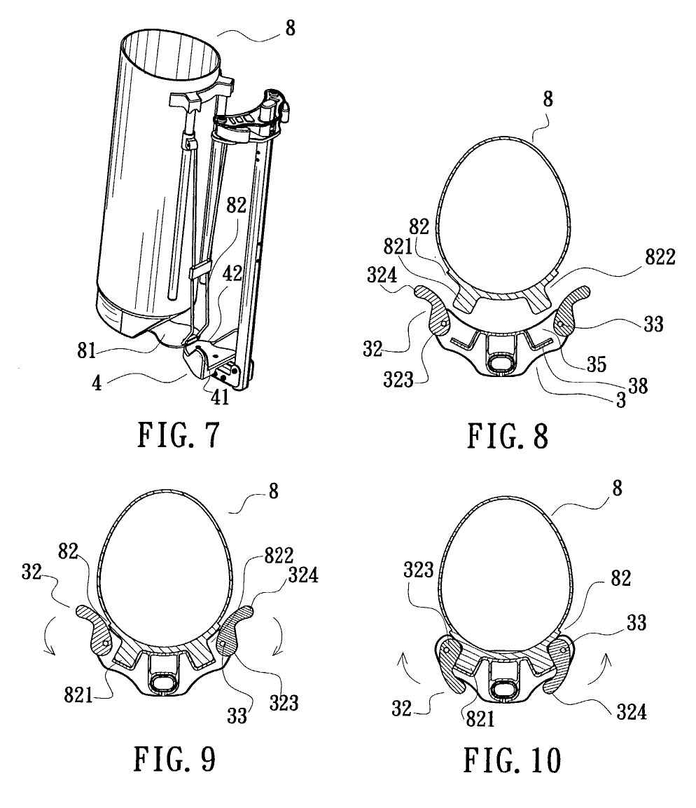

Referring to FIG. 7, the calabash-board 81 in the bottom of the golf bag 8 is being put on the down base 42 of the lower support 4, the two prominent pedestals 41 hold the calabash-board 81 tightly, and two connecting rods 82 of the golf bag 8 clip tightly the connecting tube 71 of the golf cart 7.

Referring to FIGS. 8-10, the two prominent pedestals 821 in the arc channel 82 aim at a L-unit 38 of the hollow part 35 of the upper support 3, turn the nipple parts 324 of the <-fixedly buttons 32 to make the round produment part 323 of the <-fixedly buttons 32 matching with a L-parts 822 on the out side of the prominent pedestals 821 of the arc channel 82, the golf bag 8 is combined with the golf cart 7; turn the nipple parts 324 of the <-fixedly buttons 32 to apart the upper support 3 and the golf bag 8, then make the calabash-board 81 in the down base 42 of the golf bag 8 apart the upper support 4, the golf bag 8 is being separated with the golf cart 7.

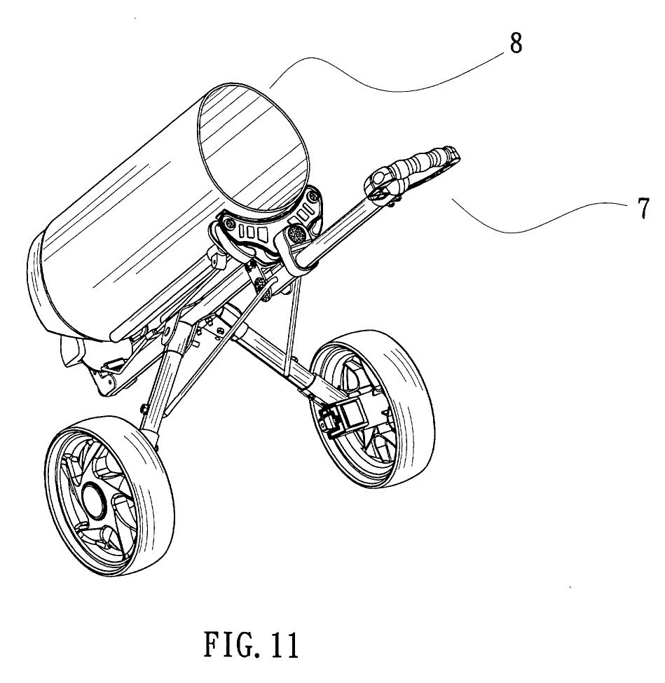

Referring to FIG. 11, the connecting structure of the golf cart with the golf bag with crutches is being set on the golf cart.

To sum up, the connecting structure of the golf cart has the advantages as following:

1. The operation is very easy and convenient.

2. It is very safe to prevent the golf bag 8 from dumping because the up and down of the field and to prevent the golf tools from being damaged, when the golf cart 7 being moved.

3. It is very durable to prevent the golf bag rubbing with the golf cart because of the golf bag is combined with the golf cart tightly.

I claim:

1. A connecting structure of a golf cart, comprising:
an upper support, comprising by a [symbol] -component, two <-fixedly buttons, two screws, two screw nuts, the [symbol] -component is symmetrical, having several different sizes of squares on the upper flat, the peripheries of the squares and the upper flat of the [symbol] -component are protrudent, the upper flat having a round drill hole 311 on each edges of two ends, having a through hole in the center, and the lower flat symmetrizes and equals the upper flat, the only different part is the place near the through hole 312 having a concave 37 on the lower flat; two hollow parts 35 being between the upper flat and lower flat;
a round protrudent part of the <-fixedly buttons aim at up and down holes, the concave of the <-fixedly buttons toward the [symbol] -component, the screw pass through the round drill holes and the through holes of the <-fixedly buttons, fastening with the screw nuts on the two ends of the [symbol] -component, the spare parts of the upper support are being combined;
a connecting tube, a long and hollow tube, the shapes of the upper and lower flats are similar with the through hole of the upper support, but smaller than the through hole of the upper support;
a lower support, having two prominent pedestals on the edges of the end of two sides, the down base is a calabash-board, having two holes;
the through holes of the upper support aim at the upper and lower flats of the connecting tube and slip in the up and down hollow parts on the back of the upper support to the position that could see the two round holes in the top back of the connecting tube, passing the screw through the round holes then fastening the screw, and the produnent parts of the two screws are against the up and down flats of the upper support, the upper support is being combined with the connecting tube;
the two screws pass through the two holes of the lower support, and pass through the two round holes of a hollow tube and fasten with the screw nuts, then the two round holes on the left and right sides of the hollow tube aim at a round hole of a L-metal frame, passing through a screw rod and fastening with screw nuts, the connecting structure of the golf cart is being combined;
the central part of the connecting tube is being riveted with an immobile piece on the wheel frame of the golf cart, an immobile article slips in the upper flat of the connecting tube, the connecting structure of the golf cart is being combined with the golf cart; and
the calabash-board in the bottom of the golf bag put on the down base of the lower support and the two connecting rod of the golf bag clip tightly the connecting tube of the golf cart, the two prominent pedestals in the arc channel aim at a L-unit of the upper support and fasten with the <-fixedly buttons, the golf bag is combined with the golf cart.

2. The connecting structure of a golf cart in accordance with claim 1, wherein the [symbol] -component is symmetrical, having several different sizes of squares on the upper flat, the peripheries of the squares and the upper flat of the [symbol] -component are protrudent, and having a round drill hole on each edges of two ends of the upper flat, having a through hole in the center; the lower flat symmetrizes and equals the upper flat, the only different part is the place near the through having a concave on the lower flat, and two hollow parts between the upper flat and the lower flat.

3. The connecting structure of a golf cart in accordance with claim 1, wherein a round protrudent part of the <-fixedly buttons aim at up and down holes, the concave of the <-fixedly buttons toward the [symbol] -component, the screw pass through the round drill holes and the through holes of the <-fixedly buttons, fastening with the screw nuts on the two ends of the [symbol] -component.

4. The connecting structure of a golf cart in accordance with claim 1, wherein the two screws pass through the two holes of the lower support, and pass through the two round holes of a hollow tube and fasten with the screw nuts, then the two round holes on the left and right sides of the hollow tube aim at a round hole of a L-metal frame, passing through a screw rod and fastening with screw nuts.

6. The connecting structure of a golf cart in accordance with claim 1, wherein the central part of the connecting tube is being riveted with an immobile piece on the wheel frame of the golf cart, an immobile article slips in the upper flat of the connecting tube, the connecting structure of the golf cart is being combined with the golf cart.
